(19) United States
(12) Patent Application Publication
(10) Pub. No.: US 2015/0042807 A1
(43) Pub. Date: Feb. 12, 2015

(54) HEAD UNIT WITH UNIFORM VISION PROCESSING UNIT INTERFACE

(71) Applicant: MAGNA ELECTRONICS INC., Auburn Hills, MI (US)

(72) Inventors: Joern Ihlenburg, Berlin (DE); Holger Hess, Aschaffenburg (DE)

(73) Assignee: MAGNA ELECTRONICS INC., Auburn Hills, MI (US)

(21) Appl. No.: 14/456,163

(22) Filed: Aug. 11, 2014

Related U.S. Application Data
(60) Provisional application No. 61/864,836, filed on Aug. 12, 2013.

(51) Int. Cl. B60R 1/00; B60R 11/04; G06K 9/00; H04N 7/18

(52) U.S. Cl. CPC B60R 1/00; H04N 7/181; H04N 7/183; B60R 11/04; G06K 9/00805; B60R 2011/004
USPC 348/148

(57) ABSTRACT

A vision system of a vehicle includes a camera, a head unit and a plurality of circuit cards. The camera has a field of view exterior of the vehicle. The head unit includes a video display for displaying images derived from a video feed from the camera. The circuit cards each include at least one video line connector configured to communicate with a video feed from the camera. The head unit includes a circuit connector configured to connect to a selected one of the circuit cards. The circuit cards provide different processing functions via universal connection with the circuit connector of the head unit and the video feed from the camera. A selected circuit card connects to the circuit connector and receives the video feed from the camera and provides the processing functions associated with the selected circuit card and outputs an output signal to the circuit connector.

### CROSS REFERENCE TO RELATED APPLICATION

The present application claims the filing benefits of U.S. provisional application, Ser. No. 61/864,836, filed Aug. 12, 2013, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a collision avoidance system or vision system or imaging system for a vehicle that utilizes one or more cameras (preferably one or more CMOS cameras) to capture image data representative of images exterior of the vehicle, and provides enhanced system applications with reduced system costs. The system of the present invention keeps camera and cabling the same, independent of the particular vehicle setup, and provides for adaptability or reconfiguration of the system via use of different add on PCBs or cards or the like. The system provides for or facilitates reduced part numbers, reduced tooling costs and reduced logistic costs, such that overall system costs are reduced or not increased significantly. The system includes only one additional connector and the overall PCB area and component count stay roughly the same.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a view of components of a vision system with a camera and display;

FIG. 3 is a schematic of the vision system of FIG. 2;

FIG. 4 is a view of components of another vision system with a camera and display;

FIG. 5 is a schematic of the vision system of FIG. 4;

FIG. 6 is a view of components of another vision system with a camera and display;

FIG. 7 is a schematic of the vision system of FIG. 6;

FIG. 8 is a view of components of a vision system with a camera and display in accordance with the present invention;

FIG. 9 is a schematic of a head unit add on card for the vision system of FIG. 8;

FIG. 10 is a schematic of a smart camera add on card for the vision system of FIG. 8;

FIG. 11 is a schematic of a head unit add on card for the vision system of FIG. 8;

FIG. 12 is an overview of a vision system of the present invention, with a front facing camera and a rear facing camera;

FIG. 13 is a schematic of the vision system of FIG. 12;

FIG. 14 is an overview of a vision system of the present invention, with a plurality of cameras;

FIG. 15 is a schematic of the ECU of the vision system of FIG. 14;

FIG. 16 is a schematic of an external ECU add on card for the vision system of FIG. 14;

FIG. 17 is an overview of a vision system of the present invention, with a plurality of cameras; and

FIG. 18 is a schematic of an external ECU add on card for the vision system of FIG. 17.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

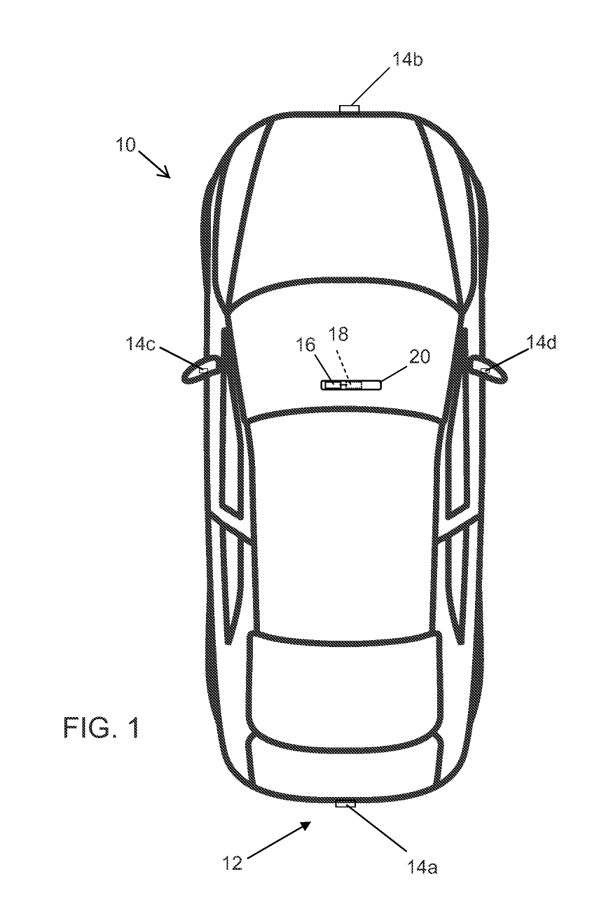

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

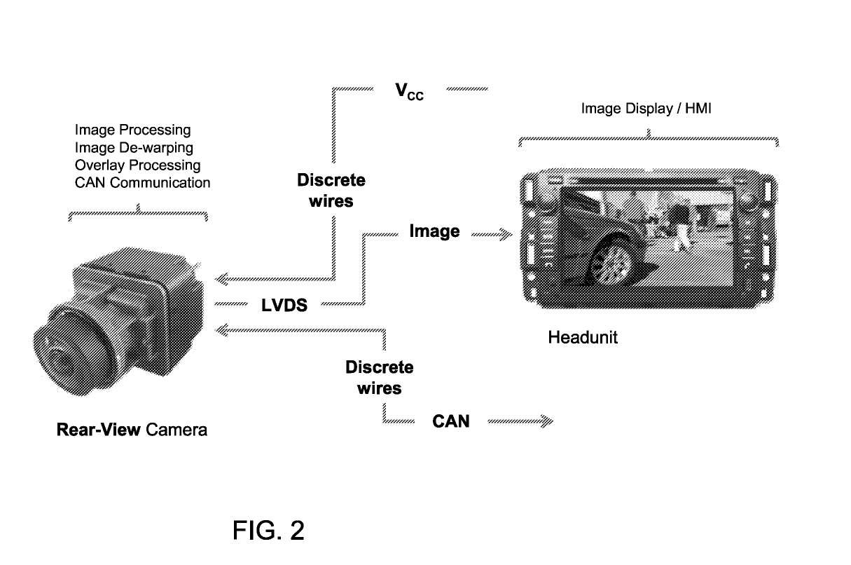

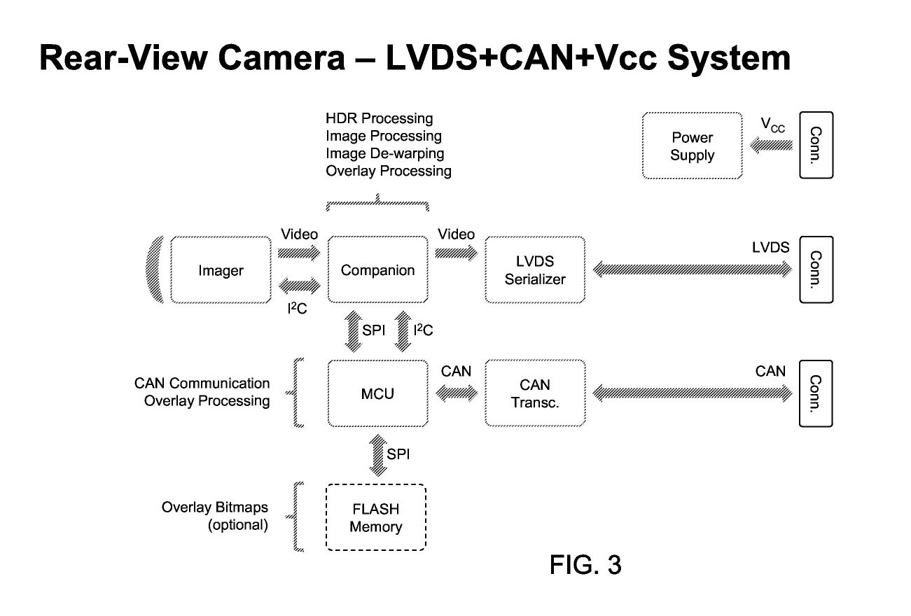

Some head units (such as shown in FIGS. 2 and 3) with an integrated display or attached display receive vision system image data and/or control data and may provide power supply to and from separate image vision processing units as a separate control device. High and low line variants come along with implementing different interfaces between head unit (HU) and image processing unit. By that, seldom unified variants are possible which results in increased costs to the OEM and Tier side by having lower volumes (tooling, wire harness and logistics) on the single solutions and having more development and testing.

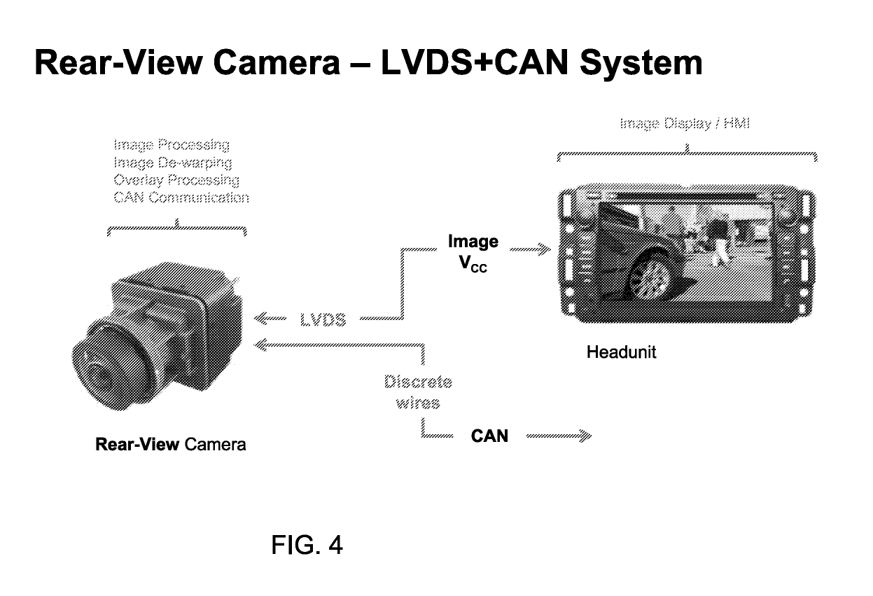

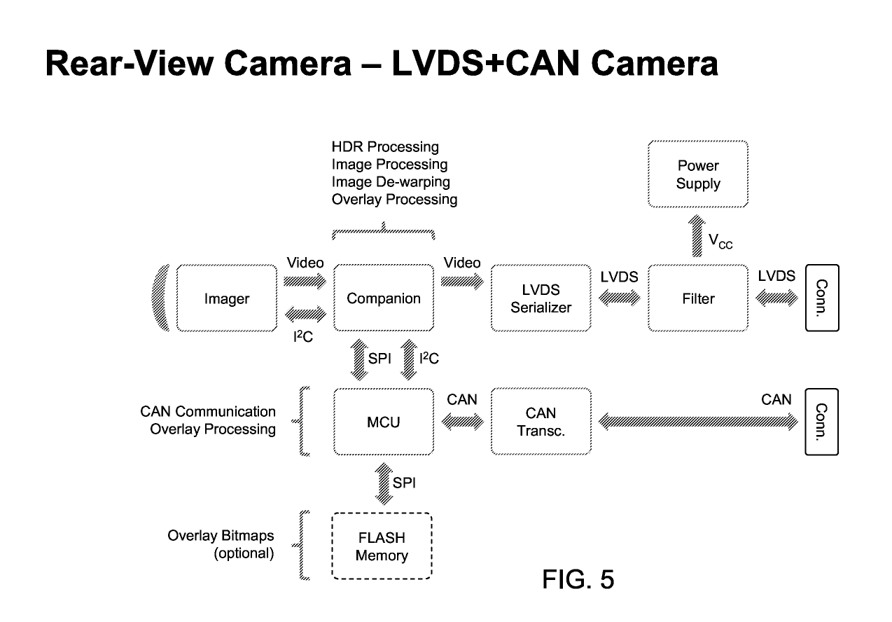

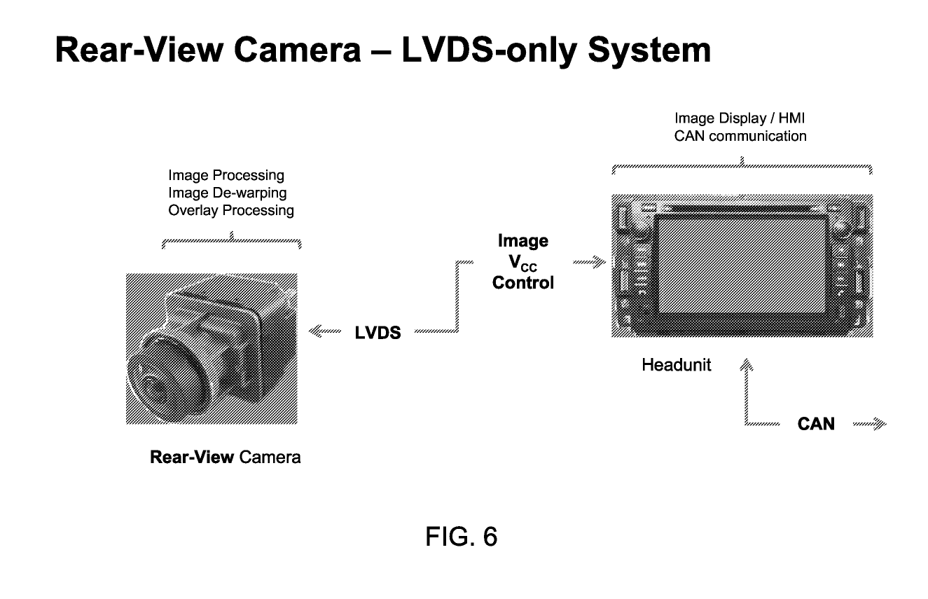

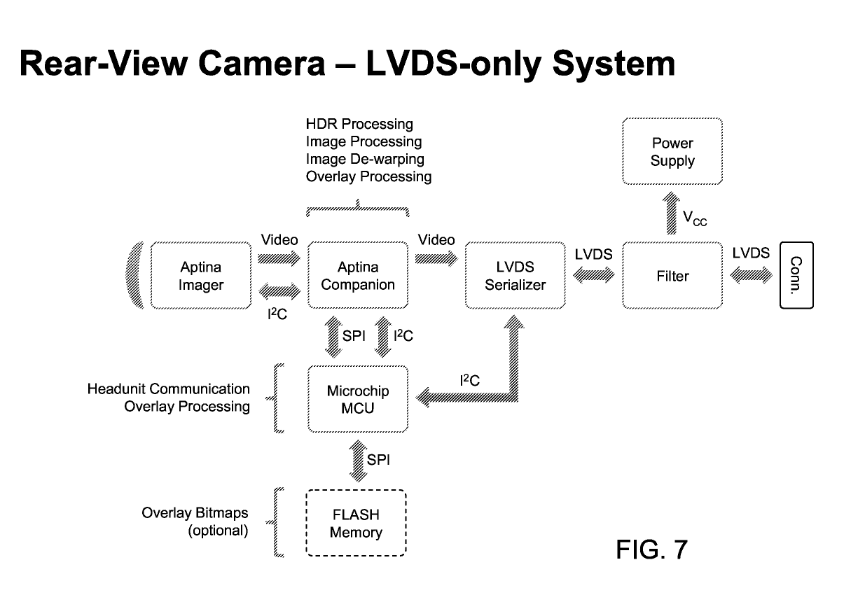

There have been attempts to combine image and control transmission via one line, also the power transmission may be incorporated (such as by utilizing aspects of the systems described in International Publication No. WO 2013/081985, which is hereby incorporated herein by reference in its entirety), and such as shown in FIGS. 4-7. This may make the head units (HUs) too special for finding reuse in slightly different architectures.

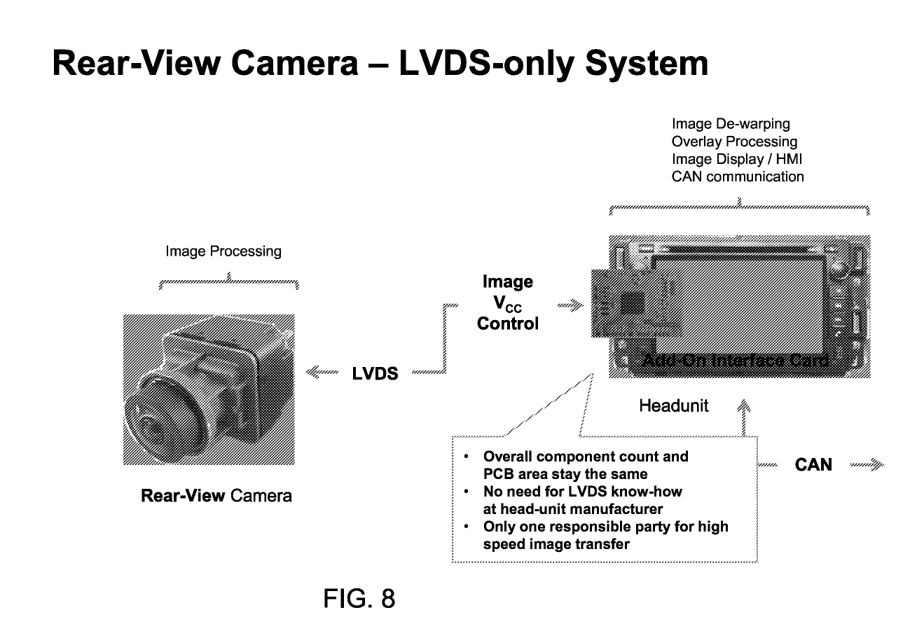

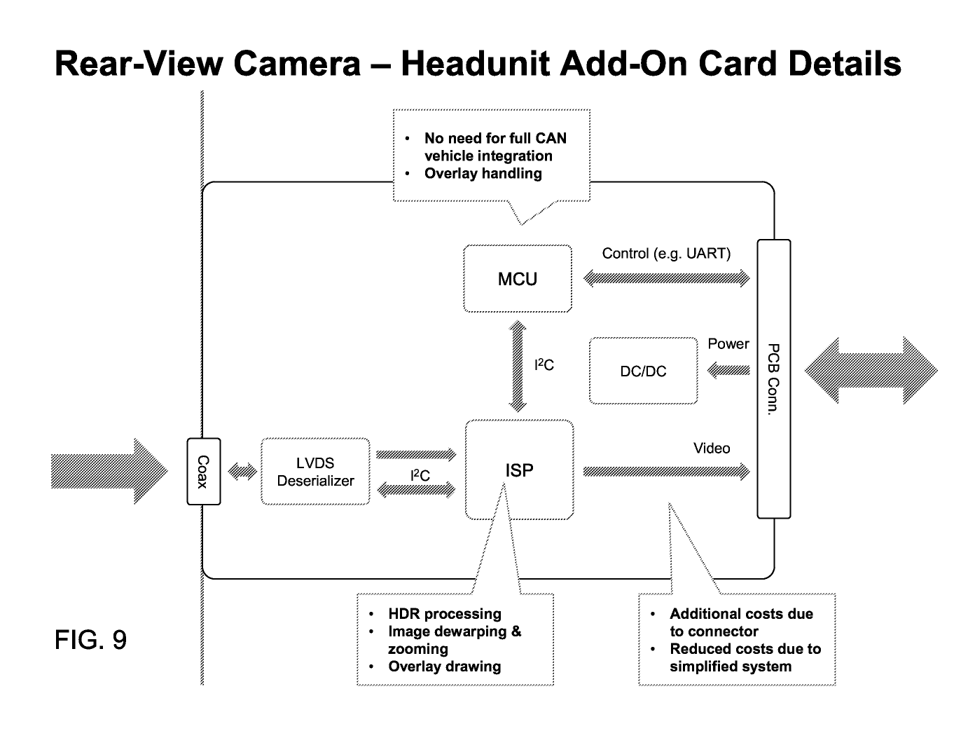

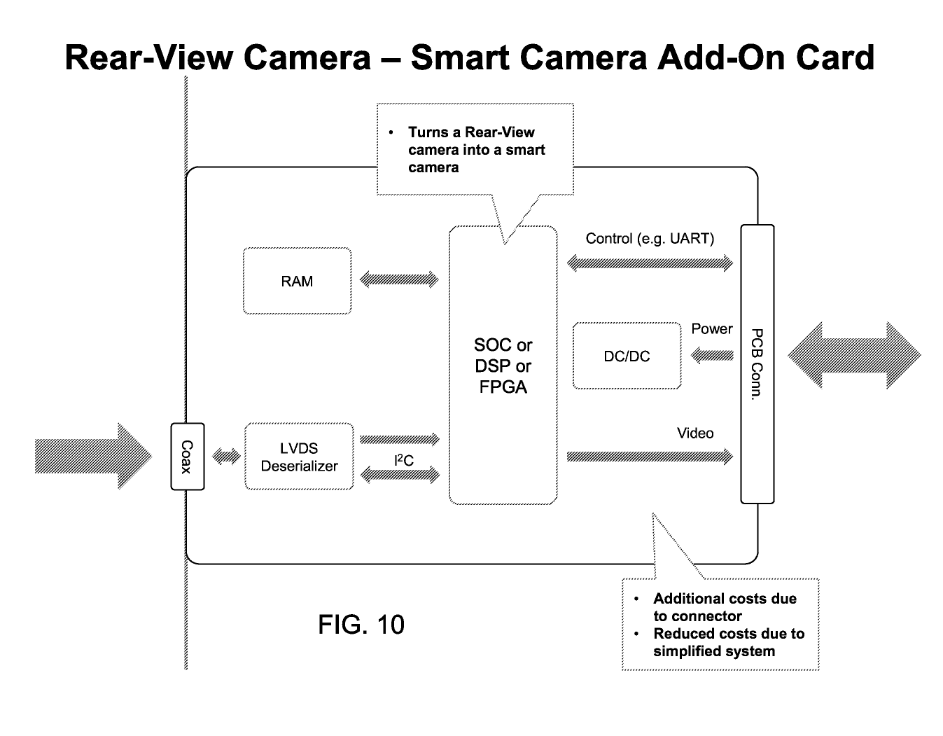

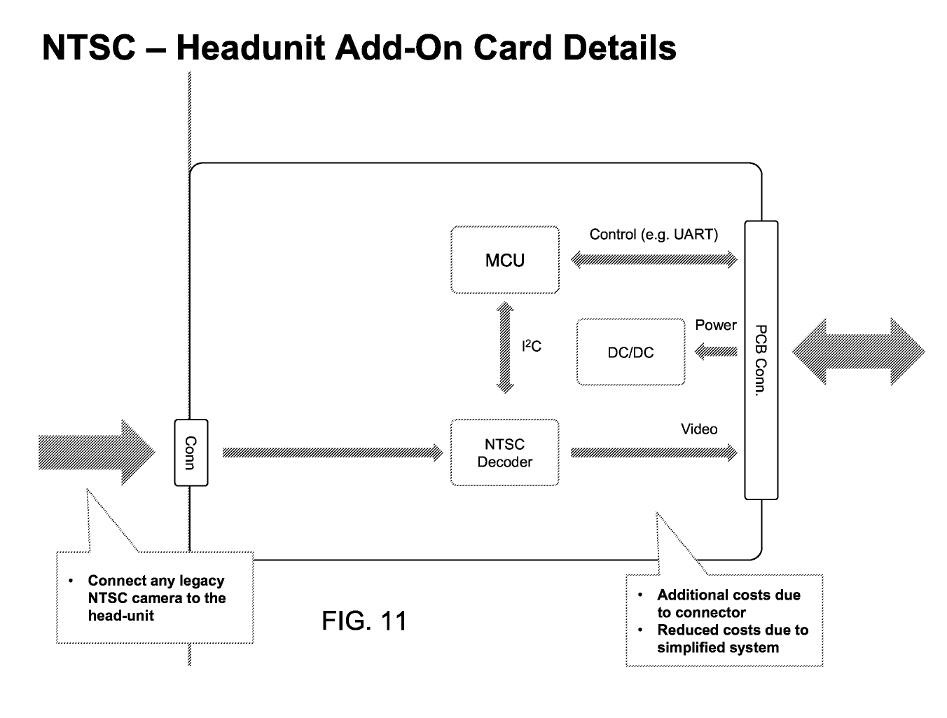

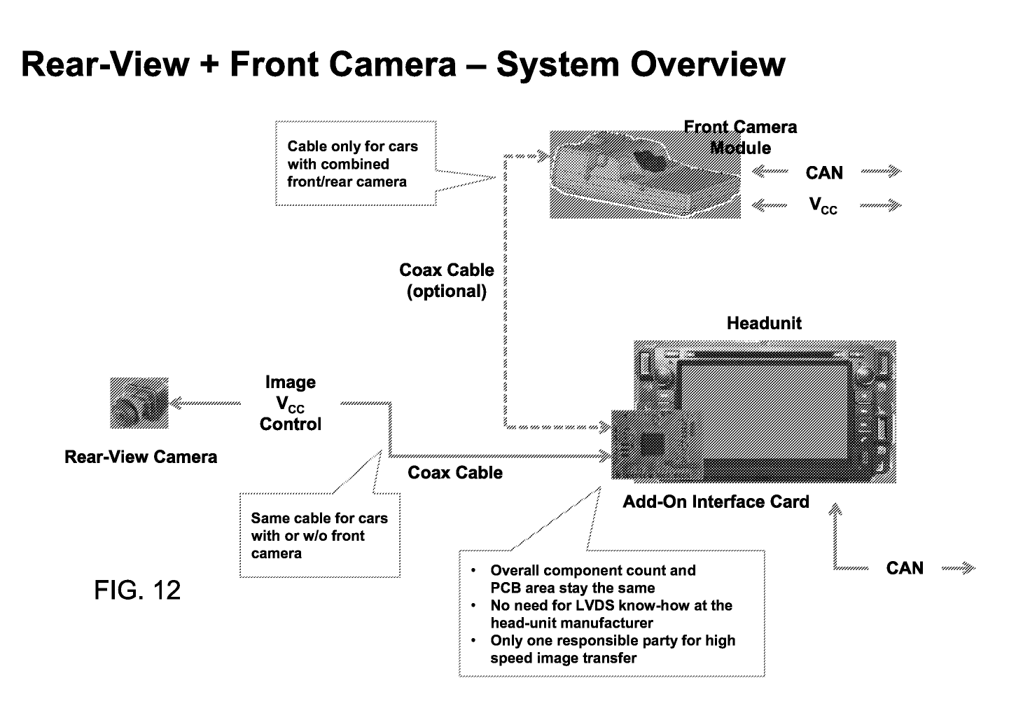

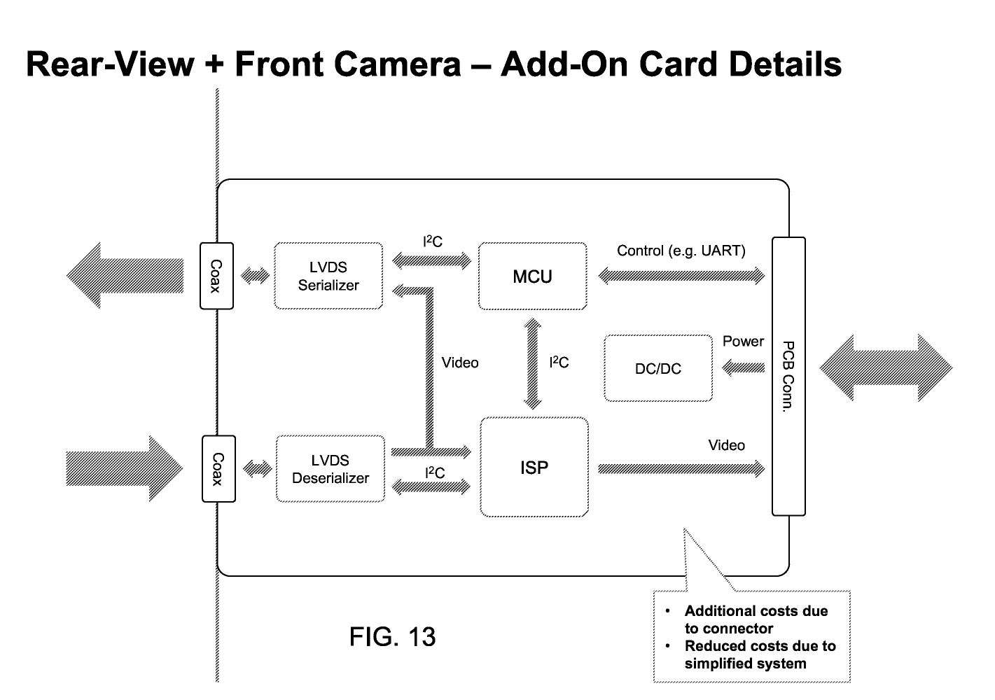

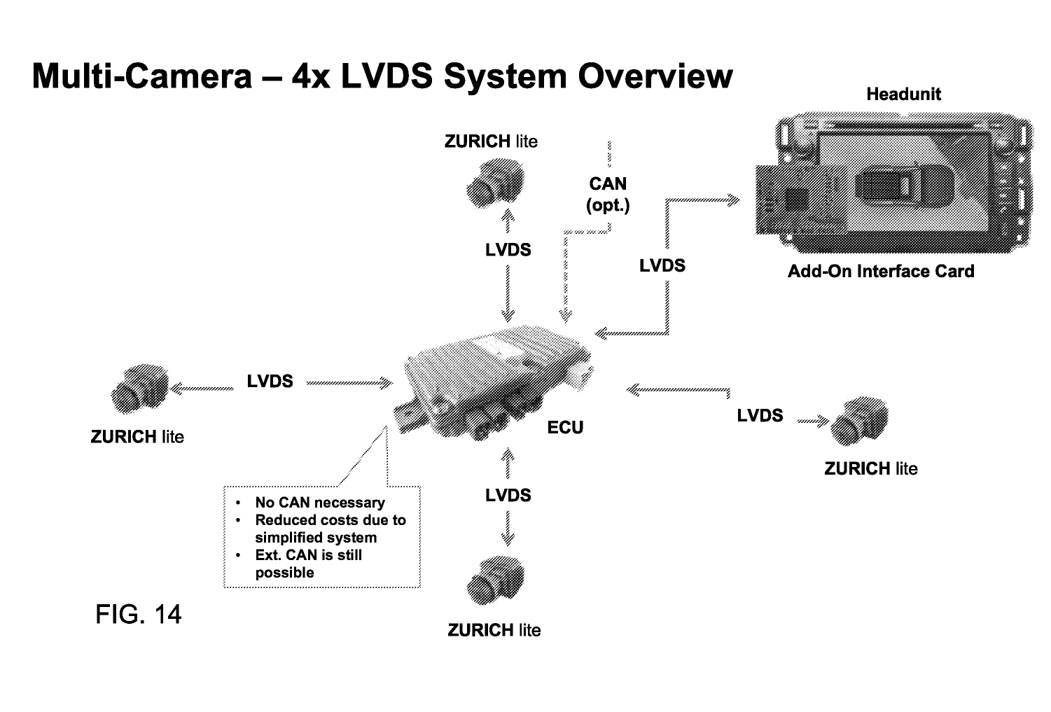

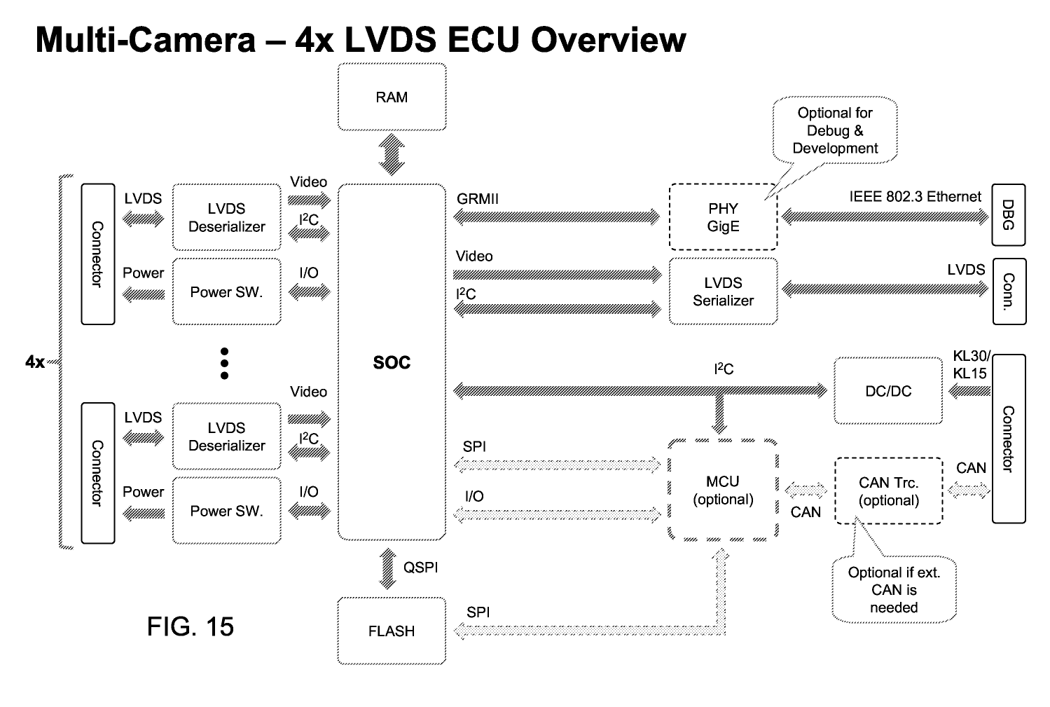

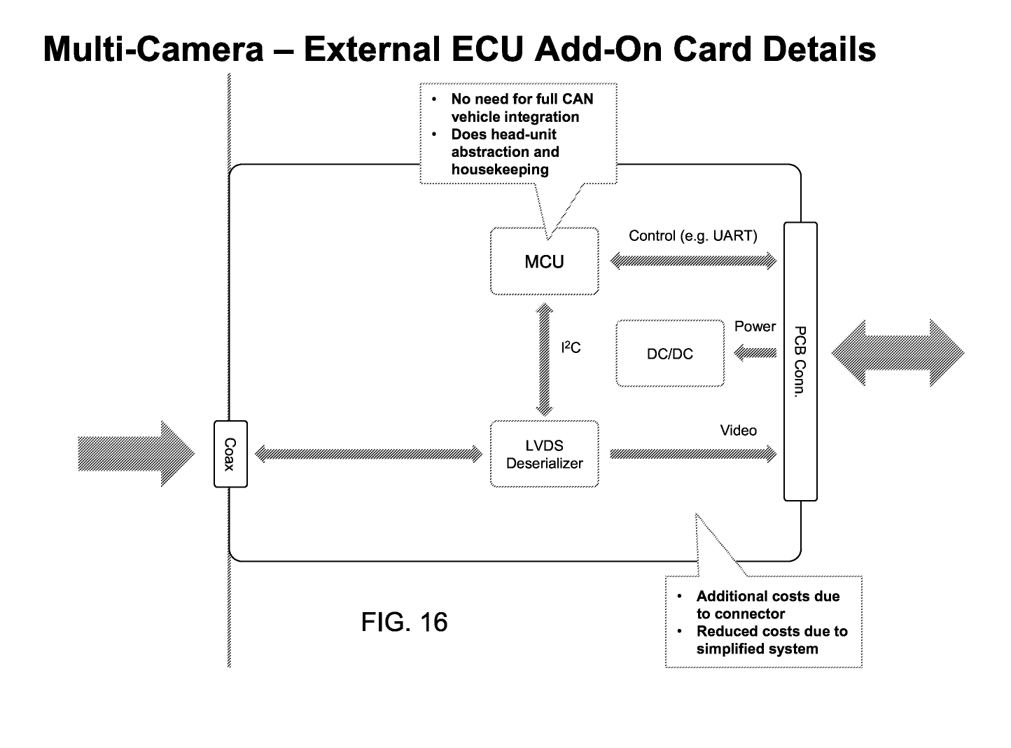

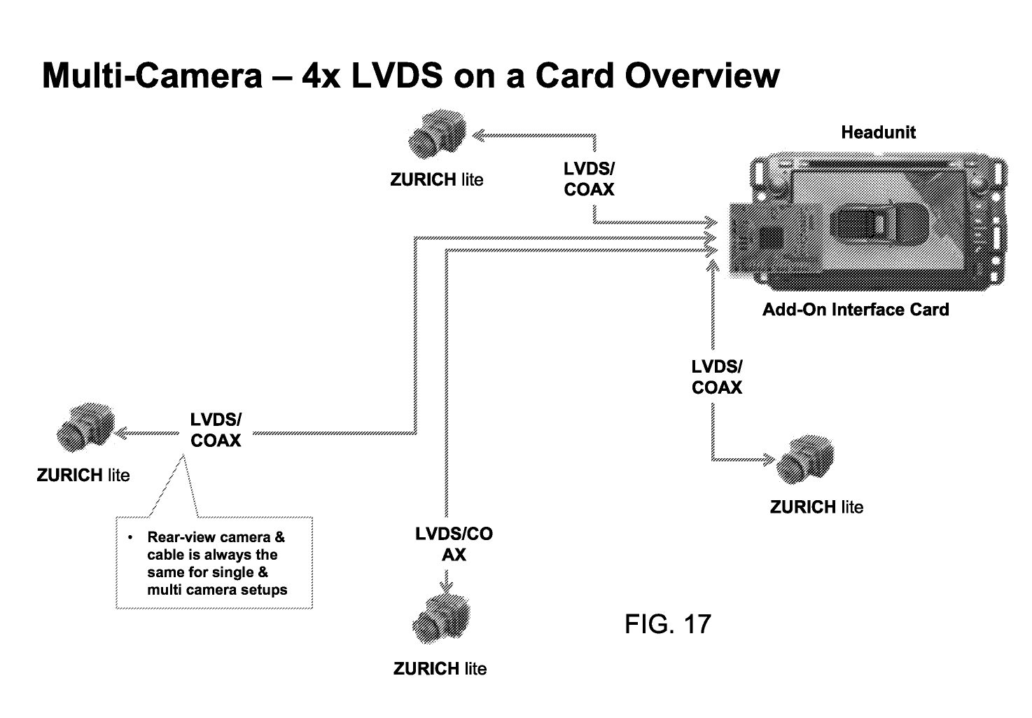

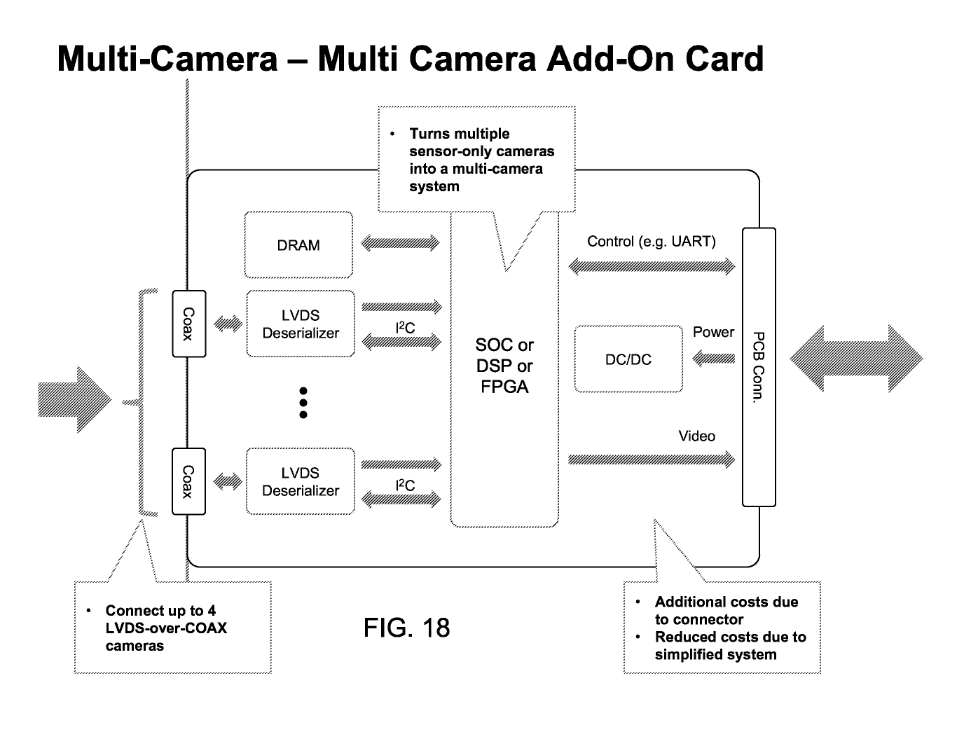

To gain customer acceptance and reduce costs and potential for design bugs, the unification of HU interfaces may be desirable. The solution of the present invention (such as in the illustrated embodiments shown in FIGS. 8-18) may have a unified or universal or common interface plug-in slot at a HU, which design can be kept whether a vehicle is set up as a high line variant or low line. In the regular cases, there may be no separate image vision processing unit but the unit may incorporate an add on PCB card matching to the HU's plug in slot by design and interfaces.

The interfaces with the selected add on image vision processing PCB card (IVPC) may include one or more of the following (beside others):
Power supply (cl. 30, cl 31, cl 15, cl 15r)
Control/UART
Video
CAN
Ethernet

The single required variants may be made by developing different IVPC for each variant. The outbounding peripheral interfaces may vary substantially by that (while the HU interfaces may be kept identical). For some data, the IVPC may act as a gateway.

Additionally, or alternately, the peripheral interfaces may include the following:
DC Power
Asynchronous LVDS via coaxial cable, optionally with DC power incorporated (see, for example, International Publication No. WO 2013/043661, which is hereby incorporated herein by reference in its entirety)
LVDS via twisted pair, optionally with DC power incorporated
NTSC (video)
Frequency modulated control and video, optionally with DC or AC power incorporated (such as by utilizing aspects of the systems described in U.S. patent application Ser. No. 14/297,663, filed Jun. 6, 2014, which is hereby incorporated herein by reference in its entirety)
MIPICSI2 (such as by utilizing aspects of the systems described in U.S. patent application Ser. No. 14/195,136, filed Mar. 3, 2014, which is hereby incorporated herein by reference in its entirety)
Ethernet
Flexray
MOST
DVI
(sub-) CAN

These IVPC may be interchangeable especially in hardware within a vehicle, an OEM platform or over OEMs. The IVPC may be interchangeable during vehicle life by a service garage or the vehicle owner. The software may be made customized for each required solution. There may be variants in software running on the same hardware. The software may be updateable (including also via remote) such as in a manner similar to the systems described in International Publication No. WO 2013/081985, which is hereby incorporated herein by reference in its entirety. The software function of HU as well as IVPC and other vehicle inherent and vehicle attachable devices may be addressable via a virtual function layer such as in a manner similar to the systems described in International Publication No. WO 2013/081985, which is hereby incorporated herein by reference in its entirety. The system and add on cards of the present invention may utilize aspects of the systems described in U.S. Pat. No. 7,937,667, which is hereby incorporated herein by reference in its entirety.

Therefore, the present invention provides a vision system that provides enhanced system applications with reduced system costs. The system of the present invention keeps camera and cabling the same, independent of the particular vehicle setup. The system provides for or facilitates reduced part numbers, reduced tooling cots and reduced logistic costs, such that overall system costs are reduced or not increased significantly. The system includes only one additional connector and the overall PCB area and component count stay roughly the same.

Add-on cards may be used in infotainment on a regular basis (such as, for example, at AUDI and Daimler). Thus, there is no need to educate head-unit manufacturers about the details of LVDS and power-over-coax type systems. Thus, the present invention provides a reduced know-how transfer and simplified testing setup. Optionally, the original equipment manufacturer (OEM) may change to a different cable/medium by simply exchanging the add-on card. Such an approach may help to ease fears of possibly making the wrong selection or decision.

The camera or sensor may comprise any suitable camera or sensor. Optionally, the camera or cameras may comprise “smart cameras” that include the imaging sensor arrays and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

Optionally, the camera or cameras which have images fully or partially computed by the add on cards have liquid lens optics, such as by utilizing aspects of the cameras described in U.S. provisional application Ser. No. 61/911,666, filed Dec. 4, 2013 (Attorney Docket MAG04 P-2221), which is hereby incorporated herein by reference in its entirety.

Optionally, the vision system Head unit, its add on cards and cameras are part of or comprise or fully or partially compute images for an in cabin imaging system, driver monitoring or driver head and eye tracking system, such as by utilizing aspects of the systems described in U.S. provisional application Ser. No. 61/981,477, filed Apr. 21, 2014 (Attorney Docket MAG04 P-2312) and/or U.S. provisional application Ser. No. 61/977,940, filed Apr. 10, 2014 (Attorney Docket MAG04 P-2307), which are hereby incorporated herein by reference in their entireties.

Optionally, the head unit's display is a head up or switchable display, such as described in U.S. provisional application Ser. No. 61/941,568, filed Feb. 19, 2014 (Attorney Docket MAG04 P-2263), which is hereby incorporated herein by reference in its entirety. The displayed images are fully or partially computed by the add on cards according the invention.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193;WO 2012/0116043; WO 2012/0145313; WO 2012/0145501; WO 2012/145818; WO 2012/145822; WO 2012/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661; WO 2013/158592 and/or PCT Application No. PCT/US2014/042229, filed Jun. 13, 2014 (Attorney Docket MAG04 FP-2334 (PCT)), and/or U.S. patent applications, Ser. No. 14/324,696, filed Jul. 7, 2014 (Attorney Docket MAG04 P-2324); Ser. No. 14/369,229, filed Jun. 27, 2014 (Attorney Docket MAG04 P-1982); Ser. No. 14/316,940, filed Jun. 27, 2014 (Attorney Docket MAG04 P-2319); Ser. No. 14/316,939, filed Jun. 27, 2014 (Attorney Docket MAG04 P-2317); Ser. No. 14/303,696, filed Jun. 13, 2014 (Attorney Docket MAG04 P-2314); Ser. No. 14/303,695, filed Jun. 13, 2014 (Attorney Docket MAG04 P-2312); Ser. No. 14/303,694, filed Jun. 13, 2014 (Attorney Docket MAG04 P-2303); Ser. No. 14/303,693, filed Jun. 13, 2014 (Attorney Docket MAG04 P-2302); Ser. No. 14/297,663, filed Jun. 6, 2014 (Attorney Docket MAG04 P-2301); Ser. No. 14/362,636, filed Jun. 4, 2014 (Attorney Docket MAG04 P-1967); Ser. No. 14/290,028, filed May 29, 2014 (Attorney Docket MAG04 P-2294); Ser. No. 14/290,026, filed May 29, 2014 (Attorney Docket MAG04 P-2293); Ser. No. 14/359,341, filed May 20, 2014 (Attorney Docket MAG04 P-1961); Ser. No. 14/359,340, filed May 20, 2014 (Attorney Docket MAG04 P-1961); Ser. No. 14/282,029, filed May 20, 02014 (Attorney Docket MAG04 P-2287); Ser. No. 14/282,028, filed May 20, 2014 (Attorney Docket MAG04 P-2286); Ser. No. 14/358,232, filed May 15, 2014 (Attorney Docket MAG04 P-1959); Ser. No. 14/272,834, filed May 8, 2014 (Attorney Docket MAG04 P-2278); Ser. No. 14/356,330, filed May 5, 2014 (Attorney Docket MAG04 P-1954); Ser. No. 14/269,788, filed May 5, 2014 (Attorney Docket MAG04 P-2276); Ser. No. 14/268,169, filed May 2, 2014 (Attorney Docket MAG04 P-2273); Ser. No. 14/264,443, filed Apr. 29, 2014 (Attorney Docket MAG04 P-2270); Ser. No. 14/354,675, filed Apr. 28, 2014 (Attorney Docket MAG04 P-1953); Ser. No. 14/248,602, filed April 9, 2014 (Attorney Docket MAG04 P-2257); Ser. No. 14/242,038, filed Apr. 1, 2014 (Attorney Docket MAG04 P-2255); Ser. No. 14/229,061, filed Mar. 28, 2014 (Attorney Docket MAG04 P-2246); Ser. No. 14/343,937, filed Mar. 10, 2014 (Attorney Docket MAG04 P-1942); Ser. No. 14/343,936, filed Mar. 10, 2014 (Attorney Docket MAG04 P-1937); Ser. No. 14/195,135, filed Mar. 3, 2014 (Attorney Docket MAG04 P-2237); Ser. No. 14/195,136, filed Mar. 3, 2014 (Attorney Docket MAG04 P-2238); Ser. No. 14/191,512, filed Feb. 27, 2014 (Attorney Docket No. MAG04 P-2228); Ser. No. 14/183,613, filed Feb. 19, 2014 (Attorney Docket No. MAG04 P-2225); Ser. No. 14/169,329, filed Jan. 31, 2014 (Attorney Docket MAG04 P-2218); Ser. No. 14/169,328, filed Jan. 31, 2014 (Attorney Docket MAG04 P-2217); Ser. No. 14/163,325, filed Jan. 24, 2014 (Attorney Docket No. MAG04 P-2216); Ser. No. 14/159,772, filed Jan. 21, 2014 (Attorney Docket MAG04 P-2215); Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAG04 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P-2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P-2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 62/018,868, filed Jun. 30, 2014; Ser. No. 62/018,867, filed Jun. 30, 2014; Ser. No. 62/010,597, filed Jun. 11, 2014; Ser. No. 62/010,596, filed Jun. 11, 2014; Ser. No. 62/007,542, filed Jun. 4, 2014; Ser. No. 62/006,391, filed Jun. 2, 2014; Ser. No. 62/003,734, filed May 28, 2014; Ser. No. 62/001,796, filed May 22, 2014; Ser. No. 62/001,796, filed May 22, 2014; Ser. No. 61/993,736, filed May 15, 2014; Ser. 61/991,810, filed May 12, 2014; Ser. No. 61/991,809, filed May 12, 2014; Ser. No. 61/990,927, filed May 9, 2014; Ser. No. 61/989,652, filed May 7, 2014; Ser. No. 61/981,938, filed Apr. 21, 2014; Ser. No. 61/977,941, filed Apr. 10, 2014; Ser. No. 61/977,940. filed Apr. 10, 2014; Ser. No. 61/977,929, filed Apr. 10, 2014; Ser. No. 61/973,922, filed Apr. 2, 2014; Ser. No. 61/972,708, filed Mar. 31, 2014; Ser. No. 61/972,707, filed Mar. 31, 2014; Ser. No. 61/969,474, filed Mar. 24, 2014; Ser. No. 61/955,831, filed Mar. 20, 2014; Ser. No. 61/953,970, filed Mar. 17, 2014; Ser. No. 61/952,335, filed Mar. 13, 2014; Ser. No. 61/952,334, filed Mar. 13, 2014; Ser. No. 61/950,261, filed Mar. 10, 2014; Ser. No. 61/950,261, filed Mar. 10, 2014; Ser. No. 61/947,638, filed Mar. 4, 2014; Ser. No. 61/947,053, filed Mar. 3, 2014; Ser. No. 61/941,568, filed Feb. 19, 2014; Ser. No. 61/935,485, filed Feb. 4, 2014; Ser. No. 61/935,056, filed Feb. 3, 2014; Ser. No. 61/935,055, filed Feb. 3, 2014; Ser. No. 61/919,129, filed Dec. 20, 2013; Ser. No. 61/919,130, filed Dec. 20, 2013; Ser. No. 61/919,131, filed Dec. 20, 2013; Ser. No. 61/919,147, filed Dec. 20, 2013; Ser. No. 61/919,138, filed Dec. 20, 2013, Ser. No. 61/919,133, filed Dec. 20, 2013; Ser. No. 61/918,290, filed Dec. 19, 2013; Ser. No. 61/915,218, filed Dec. 12, 2013; Ser. No. 61/912,146, filed Dec. 5, 2013; Ser. No. 61/911, 666, filed Dec. 4, 2013; Ser. No. 61/905,461, filed Nov. 18, 2013; Ser. No. 61/905,462, filed Nov. 18, 2013; Ser. No. 61/901,127, filed Nov. 7, 2013; Ser. No. 61/895,610, filed Oct. 25, 2013; Ser. No. 61/879,837, filed Sep. 19, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,838, filed Aug. 12, 2013 and/or Ser. No. 61/844,173, filed Jul. 9, 2013; which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and/or 6,824,281, and/or International Publication Nos. WO 2010/099416; WO 2011/028686; and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. patent application Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera disposed at a vehicle and having a field of view exterior of the vehicle;
a head unit comprising a video display for displaying images derived from a video feed from said camera;
a plurality of circuit cards each comprising a video line connector configured to connect to the video feed from said camera;
wherein said head unit comprises a circuit connector configured to connect to a selected one of said circuit cards;
wherein said plurality of circuit cards provide different processing functions via universal connection with said circuit connector of said head unit and the video feed from said camera; and
wherein the selected circuit card receives the video feed from said camera and provides the respective processing functions associated with the selected circuit card and outputs an output signal to said circuit connector of said head unit.

2. The vision system of claim 1, wherein at least some of said plurality of circuit cards are operable to generate a video output to said video display screen responsive to processing of the video feed from said camera.

3. The vision system of claim 2, wherein at least one of said plurality of circuit cards comprises software to provide an overlay at displayed images derived from the video feed of said camera.

4. The vision system of claim 1, wherein said circuit cards generate said outputs to provide respective selected types of displayed images.

5. The vision system of claim 1, wherein at least one of said plurality of circuit cards comprises an image processor for processing image data captured by said camera for detection of objects present in the field of view of said camera.

6. The vision system of claim 1, wherein at least one of said plurality of circuit cards comprises a plurality of video line connectors for connecting to a plurality of video feeds from multiple cameras of the vehicle.

7. The vision system of claim 6, wherein at least one said plurality of video line connections comprises a NTSC connection.

8. The vision system of claim 6, wherein at least one said plurality of video line connections comprises one of (i) a CameraLink connection, (ii) an Ethernet connection, (iii) a MOST connection, (iv) a DVI connection, (v) a MIPICSI2 connection and (vi) a Flexray connection.

9. The vision system of claim 6, comprising a video display screen operable to display video images derived from the video feeds from said cameras, wherein at least one of said plurality of circuit cards comprises software to provide a top down display responsive to the video feeds from said multiple cameras.

10. The vision system of claim 1, wherein said camera and cabling of said camera are common for selection of any of said plurality of circuit cards.

11. The vision system of claim 1, wherein said circuit cards are individually programmable to provide updates to software of said circuit cards.

12. A vision system of a vehicle, said vision system comprising:
a plurality of cameras disposed at a vehicle and having respective fields of view exterior of the vehicle;
a head unit comprising a video display for displaying images derived from video feeds from said cameras;
a plurality of circuit cards each comprising a plurality of video line connectors configured to connect to the video feeds from said cameras;
wherein said head unit comprises a circuit connector configured to connect to a selected one of said circuit cards;
wherein said plurality of circuit cards provide different processing functions via universal connection with said circuit connector of said head unit and the video feeds from said cameras;
wherein the selected circuit card receives the video feeds from said cameras and provides the respective processing functions associated with the selected circuit card and outputs an output signal to said circuit connector of said head unit; and
wherein at least one of said plurality of circuit cards is operable to provide a top down display at said video display screen responsive to the video feeds from said cameras.

13. The vision system of claim 12, wherein at least one of said plurality of circuit cards comprises software to provide an overlay at displayed images derived from the video feeds of said cameras.

14. The vision system of claim 12, wherein said circuit cards generate said outputs to provide respective selected types of displayed images.

15. The vision system of claim 12, wherein at least one of said plurality of circuit cards comprises an image processor for processing image data captured by said cameras for detection of objects present in the fields of view of said cameras.

16. The vision system of claim 12, wherein said cameras and cabling of said cameras are common for selection of any of said plurality of circuit cards.

17. The vision system of claim 12, wherein said circuit cards are individually programmable to provide updates to software of said circuit cards.

18. A vision system of a vehicle, said vision system comprising:
a plurality of cameras disposed at a vehicle and having respective fields of view exterior of the vehicle;
a head unit comprising a video display for displaying images derived from video feeds from said cameras;
a plurality of circuit cards each comprising a plurality of video line connectors configured to connect to the video feeds from said cameras;
wherein said head unit comprises a circuit connector configured to connect to a selected one of said circuit cards;
wherein said plurality of circuit cards provide different processing functions via universal connection with said circuit connector of said head unit and the video feeds from said cameras;
wherein the selected circuit card receives the video feeds from said cameras and provides the respective processing functions associated with the selected circuit card and outputs an output signal to said circuit connector of said head unit;
wherein at least some of said plurality of circuit cards are operable to generate a video output to said video display screen responsive to processing of the video feeds from said cameras;
wherein said circuit cards generate said outputs to provide respective selected types of displayed images; and
wherein at least one of said plurality of circuit cards is operable to process the video feeds to provide a top down display at said video display screen.

19. The vision system of claim 18, wherein at least one of said plurality of circuit cards comprises an image processor for processing image data captured by at least one of said cameras for detection of objects present in the field of view of said at least one of said cameras.

20. The vision system of claim 18, wherein said circuit cards are individually programmable to provide updates to software of said circuit cards.
